(19) United States
(12) Patent Application Publication
(10) Pub. No.: US 2024/0400872 A1
(43) Pub. Date: Dec. 5, 2024

(54) HOT-MELT ADHESIVE COMPOSITION

(71) Applicant: Bostik SA, COLOMBES (FR)

(72) Inventor: Thomas PRENVEILLE, SERQUIGNY (FR)

(21) Appl. No.: 18/698,110

(22) PCT Filed: Oct. 13, 2022
(86) PCT No.: PCT/FR2022/051931

§ 371 Date: Apr. 3, 2024

(30) Foreign Application Priority Data
Oct. 14, 2021 (FR) FR2110897

(51) Int. Cl. C09J 177/10; C08K 3/04

(52) U.S. Cl. CPC C09J 177/10; C08K 3/04; C08K 2201/001; C08K 2201/005

(57) ABSTRACT

The invention relates to a hot-melt adhesive composition comprising: i) at least one specific semicrystalline aliphatic copolyamide containing a unit Y exhibiting a Tg of less than 30° C., ii) from 3% to 35% by weight, with respect to the total weight of the composition, of at least one thermally conductive filler, the content of carbon atoms of which is of between 80% and 100%, with respect to the number of atoms constituting the filler, the composition comprising less than 20% of its components having a density of greater than 3. The invention also relates to its process of preparation and to its use.

The present invention relates to a hot-melt adhesive composition for the encapsulation of electronic devices, to a process for the preparation of such a composition and also to its use.

It is known to use polyamides as hot-melt adhesives for encapsulating electronic or mechanical devices used, for example, in the automotive fields or in the medical field. This is because plastic materials are generally used to protect batteries, whether within an automobile or else whether on a smaller scale, such as a cell phone shell. More particularly, the substrates to be encapsulated can be metals, such as copper, or polymers, such as, for example, materials making up printed circuits.

Furthermore, these materials must be electrically insulating, in order to avoid possible short circuits. They must also be heat conductors in order to make it possible for, for example a battery, if this is the element to be encapsulated, to discharge the heat which it generates during its use.

At the implementation level, the encapsulation of the parts requires being carried out at low pressure, in order not to damage the part to be molded. Encapsulation is a problematic process. The material which makes it possible to encapsulate the part is melted. It is subsequently gently deposited hot on the element to be encapsulated. The pressure at the nozzle outlet of the molten material is described as low pressure. The term “wetting” is used to define this encapsulation. This is because, if the pressure at the nozzle outlet is higher, the force applied to the part to be molded during the deposition of the molten material can damage the part said Several low-pressure injection processes are known for encapsulating parts. The process called “epoxy potting” exhibits the disadvantage of being relatively lengthy, resulting in low productivity due to the relatively slow reaction time. The chemical vapor deposition process is itself used in the field of encapsulation. However, this process is known to be dangerous.

Thus, new materials are sought which have to correspond both to specific physicochemical properties and have to make possible an easier low-pressure encapsulation process.

It turns out that, during the implementation of the encapsulation process, the materials are in the molten state, usually in a melter, for a relatively long period. It has been observed that the known compositions undergo phase segregation. This loss of homogeneity over time results in a difference in properties between the encapsulated product manufactured at the beginning of production, with the homogeneous material, and the encapsulated product manufactured at the end of production, with a nonhomogeneous material. In addition, sedimentation of the fillers, making the molten material too dense, tends to clog the outlet nozzles. Subsequently, over time, these relatively abrasive fillers damage the manufacturing plants.

There thus exists a real need to provide hot-melt adhesive compositions exhibiting good electrically insulating and thermally conductive properties, exhibiting stability over time in the molten state, and which can be easily employed at low pressure.

### SUMMARY OF THE INVENTION

The invention relates to a hot-melt adhesive composition comprising:
(i) at least one semicrystalline aliphatic copolyamide comprising at least two units corresponding to the following formula (1):

X/Y (1)
the unit X is a semicrystalline unit obtained by the polycondensation of a unit chosen from a C₆ to C₁₈ α,ω-aminocarboxylic acid, a C₆ to C₁₈ lactam and a (Ca diamine)·(Cb diacid) unit, with a representing the number of carbon atoms of the diamine and b representing the carbon number of the diacid, a being of between 2 and 18 and b being of between 4 and 18, the Ca diamine and the Cb diacid being saturated or unsaturated, linear or branched aliphatic or cycloaliphatic,
the unit Y is a unit obtained by the polycondensation of a (Cd diamine)·(Ce diacid) unit, with d representing the number of carbon atoms of the diamine and e representing the carbon number of the diacid, d and e being of between 2 and 48, the Cd diamine and the Ce diacid being saturated or unsaturated, linear or branched aliphatic or cycloaliphatic, it being possible for the Cd diamine to be a polyetheramine,
the unit Y exhibiting a Tg of less than 30° C., advantageously of less than 20° C., very advantageously of less than 0° C.,
the copolyamide exhibiting a melt viscosity, measured according to the standard ASTM D3236-88 (2009), of between 0.5 and 300 Pa·s at 200° C.,
the copolyamide constituting the matrix of the composition, and
(ii) from 3% to 35% by weight, with respect to the total weight of the composition, of at least one thermally conductive filler, the content of carbon atoms of which is of between 80% and 100%, with respect to the number of atoms constituting the filler,
the composition comprising less than 20% of its components having a density of greater than 3.

The invention also relates to a process for the preparation of the composition according to the invention.

The invention finally relates to the use of the composition for encapsulating electronic devices.

### DETAILED DESCRIPTION

The invention is now described in more detail and in a nonlimiting way in the description which follows.

Within the meaning of the present invention, the term “hot-melt” is understood to mean the ability of the composition to melt under the effect of heat.

Throughout the description, unless otherwise indicated, all the percentages indicated are molar percentages.

Within the meaning of the present invention, the expression “of between . . . and . . . ” is understood to mean that the limits are included in the range described.

### The Copolyamide

The copolyamide present in the composition according to the invention is semicrystalline and aliphatic.

The expression “semicrystalline copolyamide” covers copolyamides which exhibit both a glass transition temperature Tg and a melting point Tm. The Tg and the Tm can be determined respectively according to the standards ISO 11357-2:2013 and 11357-3:2013.

The nomenclature used to define polyamides is described in the standard ISO 1874-1:1992, “Plastics—Polyamide (PA) moulding and extrusion materials—Part 1: Designation”, in particular on page 3 (tables 1 and 2), and is well known to a person skilled in the art. In the PAL notation, PA denotes polyamide and L denotes the number of carbon atoms of the amino acid or else of the lactam. Thus, the polyamide is obtained by the polycondensation of the amino acid or of the lactam comprising L carbon atoms. In the PAMN notation, M denotes the number of carbon atoms of the diamine and N denotes the number of carbon atoms of the diacid.

It comprises at least two units corresponding to the following formula (1):

X/Y (1)
in which:
the unit X is a semicrystalline unit obtained by the polycondensation of a unit chosen from a C₆ to C₁₈ α,ω-aminocarboxylic acid, a C₆ to C₁₈ lactam and a (Ca diamine)·(Cb diacid) unit, with a representing the number of carbon atoms of the diamine and b representing the carbon number of the diacid, a being of between 2 and 18 and b being of between 4 and 18, the Ca diamine and the Cb diacid being saturated or unsaturated, linear or branched aliphatic or cycloaliphatic,
the unit Y is a unit obtained by the polycondensation of a (Cd diamine)·(Ce diacid) unit, with d representing the number of carbon atoms of the diamine and e representing the carbon number of the diacid, d and e being of between 2 and 48, the Cd diamine and the Ce diacid being saturated or unsaturated, linear or branched aliphatic or cycloaliphatic, it being possible for the Cd diamine to be a polyetheramine,
the unit Y exhibiting a Tg of less than 30° C., advantageously of less than 20° C., very advantageously of less than 0° C.,
the copolyamide exhibiting a melt viscosity, measured according to the standard ASTM D3236-88 (2009), of between 0.5 and 300 Pa·s at 200° C.,
the copolyamide constituting the matrix of the composition.

Advantageously, the polyamide of formula (1) exhibits a ratio: number of carbon atoms to number of nitrogen atoms, denoted C/N, of greater than or equal to 8.

Within the meaning of the present invention, the term “semicrystalline unit” is understood to mean a polyamide which exhibits a melting point (Tm) in DSC according to the standard ISO 11357-3:2013, and an enthalpy of crystallization during the stage of cooling at a rate of 5 K/min in DSC, measured according to the standard ISO 11357-3 of 2013, of greater than 15 J/g, preferably of greater than 30 J/g.

The unit X can result from the polycondensation of one or more C₆ to C₁₂ α,ω-aminocarboxylic acids. Preferably, the α,ω-aminocarboxylic acid is chosen from 7-aminoheptanoic acid, 11-aminoundecanoic acid and 12-aminododecanoic acid.

The unit X can result from the polycondensation of one or more C₆ to C₁₂ lactams. Preferably, the lactam is chosen from caprolactam, enantholactam and lauryllactam.

The unit X can result from the polycondensation of a (Ca diamine)·(Cb diacid) unit, with a representing the number of carbon atoms of the diamine and b representing the carbon number of the diacid, a being of between 2 and 18 and b being of between 4 and 18. More particularly, b is of between 5 and 18.

The Ca diamine can be chosen from linear or branched aliphatic diamines or cycloaliphatic diamines.

When the Ca diamine is aliphatic and linear, of formula H₂N—(CH₂)ₐ—NH₂, it is preferentially chosen from ethylenediamine (a=2), butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18) or octadecanediamine (a=18).

When the Ca diamine is aliphatic and branched, it can comprise one or more methyl or ethyl substituents on the main chain. For example, it can advantageously be chosen from 2,2,4-trimethyl-1,6-hexanediamine, 2,4,4-trimethyl-1,6-hexanediamine, 2-methyl-1,5-pentanediamine or 2-methyl-1,8-octanediamine.

When the Ca diamine is cycloaliphatic, it can be chosen from piperazine (a=4), denoted pip below, and aminoethylpiperazine (a=6).

Preferably, the Ca diamine is chosen from ethylenediamine, hexamethylenediamine, decanediamine and piperazine.

The Cb diacid can be chosen from linear or branched aliphatic diacids or cycloaliphatic diacids.

Throughout the description, the expressions “diacid”, “carboxylic diacid” and “dicarboxylic acid” denote the same product.

When the Cb diacid is aliphatic, it can be chosen from adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanedioic acid (b=18) or octadecenedioic acid (b=18).

When the diacid is cycloaliphatic, it can comprise the following carbon backbones: norbornyl, cyclohexyl, dicyclohexyl or dicyclohexylpropane.

Preferably, the unit X is chosen from caprolactam, enantholactam and lauryllactam, 7-aminoheptanoic acid, 11-aminoundecanoic acid and 12-aminododecanoic acid, PA 26, PA 29, PA 210, PA 212, PA 214, PA 218, PA 56, PA 59, PA 510, PA 66, PA 69, PA 610, PA 512, PA 612, PA 514, PA 614, PA 618, PA pip10, PA pip12, PA 1010, PA 1012, PA 1014, PA 1018, PA 1210, PA 1212, PA 1214 and PA 1218. More particularly, the unit X is chosen from caprolactam, lauryllactam, 11-aminoundecanoic acid, PA 26, PA 29, PA 210, PA 212, PA 214, PA 218, PA 59, PA 510, PA 69, PA 610, PA 512 and PA 612.

Preferably, the unit X is chosen from an amino acid and a lactam or PA 26, PA 29, PA 210, PA 212, PA 214, PA 218, PA 59, PA 510, PA 66, PA 69, PA 610, PA 512 or PA 612; more particularly, the unit X is chosen from amino acids and lactams exhibiting a number of carbon atoms of greater than 6. More particularly, the unit X is a PA 6, a PA 11, a PA 12, a PA 210, a PA 212, a PA 69, a PA 610, or a PA 612.

The unit Y is obtained by the polycondensation of a (Cd diamine)·(Ce diacid) unit, with d representing the number of carbon atoms of the diamine and e representing the carbon number of the diacid, d and e being of between 2 and 48, the Cd diamine and the Ce diacid being saturated or unsaturated and linear or branched aliphatic, the Cd diamine being chosen from aliphatic diamines, cycloaliphatic diamines and polyetheramines.

The Cd diamine can be chosen from linear or branched aliphatic diamines or cycloaliphatic diamines, as defined above for the Ca diamines.

The Cd diamine can also be chosen from eicosanediamine (d=20) and docosanediamine (d=22).

The Cd diamine can also originate from the amination of polymerized fatty acids, as defined below. The Cd diamine can be a C₃₆ or C₄₄ diamine.

The Cd diamine can also be chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), bis(p-aminocyclohexyl)methane (PACM) and isopropylidenedi(cyclohexylamine) (PACP), isophoronediamine (f=10), piperazine (f=4), denoted pip below, or aminoethylpiperazine. It can also comprise the following carbon backbones: norbornylmethane, cyclohexylmethane, dicyclohexylpropane, di(methylcyclohexyl) or di(methylcyclohexyl)propane. A nonexhaustive list of these cycloaliphatic diamines is given in the publication “Cycloaliphatic Amines” (Encyclopedia of Chemical Technology, Kirk-Othmer, 4th Edition (1992), pp. 386-405).

The Cd diamine can also be a polyetheramine, that is to say a polyoxyalkylenediamine. Preferably, it is a polyoxyalkylene chain carrying an amine group at the chain end. The polyoxyalkylene chain preferably comprises oxyethylene (POE), oxypropylene (POP) or oxytetramethylene (POTM) groups, alone or as a mixture. When the groups are as a mixture, POE and POP or also POTM and POP mixtures are preferred.

These compounds can be obtained by cyanoacetylation of α,ω-dihydroxylated aliphatic polyoxyalkylenes, called polyetherdiols. The polyetheramine is preferably chosen from commercially available products, in particular sold by Huntsman under the Jeffamine® and Elastamine® brands (for example Jeffamine® D400, D2000, ED 2003 or XTJ 542, Elastamine® RT 1000, RP 405 or RP 2009) or under the Baxxodur® brand by BASF (for example Baxxodur® EC 302, EC 301, EC 303 or EC 311).

Preferably, the number-average molecular weight of the polyetheramine is of between 60 and 2000 g·mol⁻¹, more particularly between 80 and 1500 g·mol⁻¹ and more preferably still between 100 and 500 g·mol⁻¹.

The Cd diamine can also originate from the amination of polymerized fatty acids, as defined below. These diamines are commercially available under the brand name “Versamine” from Cognis Corporation (BASF) and under the brand name Priamine® from Croda.

The Ce diacid can be chosen from linear or branched aliphatic diacids or cycloaliphatic diacids, as defined above for the Cb diacids.

The Ce diacid can also be chosen from eicosanedioic acid (e=20), docosanedioic acid (e=22) and fatty acid dimers.

The Ce diacid can originate from polymerized fatty acids. These polymerized fatty acids denote compounds produced from coupling reactions of unsaturated fatty acids, which result in mixtures of products carrying two acid functions (denoted acid dimers) or three acid functions (denoted acid trimers). This coupling can be a combination or condensation reaction of 2 moles of an unsaturated monocarboxylic acid, it being possible for the monoacids to be identical or different. This dimerization reaction can be carried out according to catalytic or noncatalytic polymerization methods according to known methods. For example, the C₃₆ dimer diacid can be obtained by dimerization of an unsaturated C₁₈ monoacid, such as oleic acid, linoleic acid, linolenic acid and their mixture. These mixtures are present, for example, in tall oil. Generally, these mixtures comprise predominantly the dimer, and in lesser amounts the monomer, the trimer and oligomers. After separation, the fatty acid dimers are obtained predominantly from 75% to more than 98%, as a mixture in particular with the corresponding monomer, “1 and ½ mer” and trimer.

Dimer diacids can be obtained from C14 myristoleic acid, C16 palmitoleic acid, C16 sapienic acid, C18 oleic acid, C18 elaidic acid, C18 trans-vaccenic acid, C18 linoleic acid, C18 linolelaidic acid, C18 α-linolenic acid, C18 γ-linolenic acid, C20 11-eicosenoic acid, C20 eicosapentaenoic acid, C20 dihomo-γ-linolenic acid, C20 arachidonic acid, C22 erucic acid, C22 clupanodonic acid, C22 docosahexaenoic acid, C24 nervonic acid and their mixture.

Polymerized fatty acids are commercially available, and in particular the product having the brand name Pripol® sold by Croda can be used, and also the product having the brand name Empol® sold by Cognis or the product having the brand name Unydime® sold by Kraton or the product having the brand name Radiacid® sold by Oleon.

The fatty acid dimers can subsequently be converted into amine dimers, by transformation of the two acid functions into amine functions, or into amino acid dimers, by transformation of one of the acid functions into an amine function.

Preferably, the diacids used for the unit Y are acid dimers, and more particularly the C₃₆ and C₄₄ dimers are used.

Preferably, the unit Y is chosen from PA 236, PA 536, PA 636, PA 1036, PA pip36, PA pip44, PA 244, PA 544, PA 644, PA 1044, PA POP36, PA POP44, PA POP6, PA POP9, PA POP10, PA POP12 or PA POP14, POP being a polyetheramine with a molar mass of between 60 and 2000 g/mol.

The unit Y of the copolyamide according to the invention preferably exhibits a Tg of less than 30° C., advantageously of less than 0° C. The glass transition temperature noted can be determined by differential scanning calorimetry (DSC) according to the standard ISO 11357-2: 2013, Plastics—Differential Scanning Calorimetry (DSC) Part 2. The heating and cooling rates are 20° C./min.

The copolyamide according to the invention comprises from 30 mol % to 99.5 mol % of unit X and from 0.5 mol % to 70 mol % of unit Y, preferably from 40 mol % to 98 mol % of unit X and from 2 mol % to 60 mol % of unit Y, and more particularly from 50 mol % to 90 mol % of unit X and from 10 mol % to 50 mol % of unit Y.

The molar percentages of the units X and Y are measured by calculating the percentage of the number of moles of monomers constituting the unit X, for example with respect to the sum of the number of moles of all of the monomers constituting the copolyamide, that is to say X and Y, this being done while excluding the chain limiter: the diamine or the diacid in excess is not counted. The following formula illustrates the calculation:

$$\% mol = \frac{n ( monomers of the unit X ) * 100}{\sum n ( monomers of the copolyamide )}$$

The copolyamide according to the invention exhibits a melt viscosity, measured according to the standard ASTM D3236-88 (2009), of between 0.5 and 300 Pa·s at 200° C., preferably from 0.5 to 200 Pa·s, more preferably still from 1 to 100 Pa·s at 200° C., and more particularly from 2 to 30 Pa·s at 200° C. More particularly, the melt viscosity is measured with the help of a Brookfield rheometer using the SC 4-27 module according to the standard ASTM D3236-88 (2009) at 200° C.

The copolyamide according to the invention preferably exhibits a Tg of less than 20° C., advantageously of less than 0° C. The glass transition temperature noted can be determined by differential scanning calorimetry (DSC) according to the standard ISO 11357-2: 2013, Plastics—Differential Scanning Calorimetry (DSC) Part 2. The heating and cooling rates are 20° C./min.

Preferably, the copolyamide according to the invention comprises at least one of the units chosen from PA 26, PA 29, PA 210, PA 212, PA 214, PA 218, PA 56, PA 59, PA 510, PA 512, PA 66, PA 69, PA 610, PA 612, PA 6, PA 11, PA 12, PA 1010, PA 1012, PA 1212, PA pip10, PA pip36, PA pip44, PA POP40036, PA POP40044, PA POP40010, PA POP4006, PA POP200036, PA POP200044, PA POP200010, PA POP20006, PA3636, PA3644, PA 4436, PA 4444 and their mixture.

Preferably, the copolyamide according to the invention is chosen from the following structures: PA 26/pip36, PA 210/pip36, PA 212/pip36, PA 214/pip36, PA 218/pip36, PA 59/pip36, PA 510/pip36, PA 512/pip36, PA 610/pip36, PA 612/pip36, PA6/pip36, PA1010/pip36, PA 1012/pip36, PA 1212/pip36, PA 26/pip44, PA 210/pip44, PA 212/pip44, PA 214/pip44, PA 218/pip44, PA 59/pip44, PA 510/pip44, PA 512/pip44, PA 610/pip44, PA 612/pip44, PA6/pip44, PA1010/pip44, PA 1012/pip44, PA 1212/pip44, PA 26/POP40036, PA 210/POP40036, PA 212/POP40036, PA 214/POP40036, PA 218/POP40036, PA 59/POP40036, PA 510/POP40036, PA 512/POP40036, PA 610/POP40036, PA 612/POP40036, PA6/POP40036, PA1010/POP40036, PA 1012/POP40036, PA 1212/POP40036, PA 26/POP40010, PA 210/POP40010, PA 212/POP40010, PA 214/POP40010, PA 218/POP40010, PA 59/POP40010, PA 510/POP40010, PA 512/POP40010, PA 610/POP40010, PA 612/POP40010, PA6/POP40010, PA1010/POP40010, PA 1012/POP40010, PA 1212/POP40010, PA 26/POP4006, PA 210/POP4006, PA 212/POP4006, PA 214/POP4006, PA 218/POP4006, PA 59/POP4006, PA 510/POP4006, PA 512/POP4006, PA 610/POP4006, PA 612/POP4006, PA6/POP4006, PA1010/POP4006, PA 1012/POP4006, PA 1212/POP4006, PA 26/3636, PA 210/3636, PA 212/3636, PA 214/3636, PA 218/3636, PA 59/3636, PA 510/3636, PA 512/3636, PA 610/3636, PA 612/3636, PA 6/3636, PA 11/3636, PA 12/3636 and PA 11/3636/pip36, PA1010/3636, PA 1012/3636, PA 1212/3636, PA 26/POP200036, PA 210/POP200036, PA 212/POP200036, PA 214/POP200036, PA 218/POP200036, PA 59/POP200036, PA 510/POP200036, PA 512/POP200036, PA 610/POP200036, PA 612/POP200036, PA 6/POP200036, PA 1010/POP200036, PA 1012/POP200036, PA 1212/POP200036, PA 26/pip36/POP40036, PA 210/pip36/POP40036, PA 212/pip36/POP40036, PA 214/pip36/POP40036, PA 218/pip36/POP40036, PA 59/pip36/POP40036, PA 510/pip36/POP40036, PA 512/pip36/POP40036, PA 610/pip36/POP40036, PA 612/pip36/POP40036, PA 6/pip36/POP40036, PA 1010/pip36/POP40036, PA 1012/pip36/POP40036, PA 1212/pip36/POP40036, PA 26/pip36/POP200036, PA 210/pip36/POP200036, PA 212/pip36/POP200036, PA 214/pip36/POP200036, PA 218/pip36/POP200036, PA 59/pip36/POP200036, PA 510/pip36/POP200036, PA 512/pip36/POP200036, PA 610/pip36/POP200036, PA 612/pip36/POP200036, PA 6/pip36/POP200036, PA 1010/pip36/POP200036, PA 1012/pip36/POP200036, PA 1212/pip36/POP200036, PA 26/pip36/POP4006, PA 210/pip36/POP4006, PA 212/pip36/POP4006, PA 214/pip36/POP4006, PA 218/pip36/POP4006, PA 59/pip36/POP4006, PA 510/pip36/POP4006, PA 512/pip36/POP4006, PA 610/pip36/POP4006, PA 612/pip36/POP4006, PA 6/pip36/POP4006, PA1010/pip36/POP4006, PA 1012/pip36/POP4006, PA 1212/pip36/POP4006, PA 26/pip36/POP20006, PA 210/pip36/POP20006, PA 212/pip36/POP20006, PA 214/pip36/POP20006, PA 218/pip36/POP20006, PA 59/pip36/POP20006, PA 510/pip36/POP20006, PA 512/pip36/POP20006, PA 610/pip36/POP20006, PA 612/pip36/POP20006, PA 6/pip36/POP20006, PA1010/pip36/POP20006, PA 1012/pip36/POP20006 or PA 1212/pip36/POP20006; POP20006 means that this is a unit resulting in the condensation of a polyetheramine of polyoxypropylene formula having a molar mass of 2000 g/mol with a C₆ diacid.

In a particularly preferred way, the copolyamide according to the invention comprises a unit X chosen from a diamine·diacid unit and a unit Y comprising piperazine as Cd diamine and a diacid comprising more than 6 carbon atoms as Ce diacid.

According to another preferred embodiment, the Ce diacid is a C₃₆ or C₄₄ acid dimer.

According to yet another embodiment, the copolyamide according to the invention comprises a unit X of (Ca diamine)·(Cb diacid) type comprising a mean number of carbon atoms per nitrogen atom of greater than or equal to 6 and a unit Y comprising piperazine as Cd diamine and a diacid comprising more than 6 carbon atoms as Ce diacid.

Preferably, the copolyamide according to the invention comprises, as Ce diacid, an acid dimer or else a polyetheramine as Cd diamine.

According to a preferred embodiment, the copolyamide according to the invention is chosen from PA 26/pip36, PA 210/pip36, PA 59/pip36, PA 510/pip36, PA 512/pip36, PA 610/pip36, PA 210/POP40036, PA 59/POP40036, PA 510/POP40036, PA 610/POP40036, PA 210/POP40010, PA 59/POP4009, PA 510/POP40010, PA 26/POP4006, PA 210/POP4006, PA 610/POP4006, PA 26/pip36/POP40036, PA 210/pip36/POP40036, PA 510/pip36/POP40036, PA 610/pip36/POP40036, PA 6/pip36/POP40036, PA 210/pip36/POP200036, PA 59/pip36/POP200036, PA 510/pip36/POP200036, PA 512/pip36/POP200036, PA 610/pip36/POP200036, PA 210/pip36/POP20006, PA 610/pip36/POP20006, PA 6/3636, PA 11/3636, PA 12/3636 and PA 11/3636/pip36.

According to one embodiment of the invention, the copolyamide consists of the two units X and Y defined above.

According to another embodiment, which is preferred, the copolyamide comprises more than two units X and Y defined above. Preferably, the copolyamide included in the composition according to the invention comprises at least three different units. For example, the copolyamide according to the invention can comprise two units X and one unit Y, one unit X and two units Y or also two units X and two units Y. Preferably, the copolyamide included in the composition according to the invention is a terpolyamide and a tetrapolyamide.

Preferably, the copolyamide according to the invention comprises fatty acid dimer, advantageously in a content of 1 mol % to 35 mol %, preferably of 2 mol % to 30 mol %, preferentially of 7 mol % to 25 mol %, with respect to the total number of moles of the copolyamide.

Preferably, the copolyamide according to the invention comprises a content of polyetherdiamine of between 0.5 mol % and 25 mol %, preferably between 1 mol % and 22 mol %, preferentially between 1.5 mol % and 14 mol %, with respect to the total number of moles of the copolyamide.

The piperazine content in the copolyamide is preferably less than 40 mol %, advantageously less than 30 mol %, very advantageously less than 20 mol %, with respect to the total number of moles of the copolyamide.

### Chain Limiter

The copolyamides of the invention are synthesized conventionally, in the presence, if need be, of chain limiters or chain terminators.

The chain terminators suitable for reacting with the terminal amine function can be monocarboxylic acids, anhydrides, such as phthalic anhydride, monohalogenated acids, monoesters or monoisocyanates.

Preferably, monocarboxylic acids are used. They can be chosen from aliphatic monocarboxylic acids, such as acetic acid, propionic acid, lactic acid, valeric acid, caproic acid, capric acid, lauric acid, tridecylic acid, myristic acid, palmitic acid, stearic acid, pivalic acid and isobutyric acid; alicyclic acids, such as cyclohexanecarboxylic acid; aromatic monocarboxylic acids, such as benzoic acid, toluic acid, α-naphthalenecarboxylic acid, β-naphthalenecarboxylic acid, methylnaphthalenecarboxylic acid and phenylacetic acid; and their mixtures.

Preferred compounds are aliphatic acids, and in particular acetic acid, propionic acid, lactic acid, valeric acid, caproic acid, capric acid, lauric acid, tridecylic acid, myristic acid, palmitic acid and stearic acid.

Mention may be made, among the chain terminators suitable for reacting with the terminal acid function, of monoamines, monoalcohols and monoisocyanates.

Preferably, monoamines are used. They can be chosen from aliphatic monoamines, such as methylamine, ethylamine, propylamine, butylamine, hexylamine, octylamine, decylamine, laurylamine, stearylamine, dimethylamine, diethylamine, dipropylamine and dibutylamine; alicyclic amines, such as cyclohexylamine and dicyclohexylamine; aromatic monoamines, such as aniline, toluidine, diphenylamine and naphthylamine; and their mixtures.

The preferred compounds are butylamine, hexylamine, octylamine, decylamine, laurylamine, stearylamine, cyclohexylamine and aniline.

The chain limiters can also be a dicarboxylic acid, which is introduced in excess with respect to the stoichiometry of the diamine(s); or also a diamine, which is introduced in excess with respect to the stoichiometry of the diacid(s).

According to a preferred embodiment, the copolyamide present in the composition according to the invention is wholly or partly a recycled copolyamide. When the polyamide is a recycled polyamide, it contains functions resulting from oxidation reactions chosen from imide, alcohol or carboxylic acid functions, preferably imide or alcohol functions, in a molar ratio, with respect to the amide functions, greater than that of the same nonrecycled polyamide.

According to one embodiment, said molar ratio of the functions resulting from oxidation reactions, that is to say the sum of the number of moles of the imide, acid and alcohol functions to the number of moles of amide functions of the copolyamide, is of between 1/10 000 and 1/20.

This ratio can be measured by calculating the concentrations by proton NMR. The copolyamide sample is prepared by dissolving the copolyamide in d₂-dichloromethane, while adding HFIP (hexafluoroisopropanol).

In a first alternative form, said molar ratio of the imide functions is of between 1/1000 and 1/20, in particular between 1/500 and 1/20, especially between 1/200 and 1/50.

In a second alternative form, said molar ratio of the carboxylic acid functions is of between 1/5000 and 1/20, in particular between 1/3000 and 1/50, very advantageously of between 1/500 and 1/25.

In a third alternative form, said molar ratio of the alcohol functions is of between 1/1000 and 1/20 and advantageously of between 1/1000 and 1/25, very advantageously of between 1/200 and 1/50.

Preferably, the copolyamide present in the composition preferably exhibits a melting point of between 10° and 220° C., advantageously between 12° and 200° C., very advantageously between 13° and 180° C.

The water content of the copolyamide after exposure to 23° C. and 50% relative humidity (measurement carried out at equilibrium) is preferably of between 0.1% and 1.2% by weight, advantageously from 0.15% to 0.7% by weight, with respect to the total weight of the copolyamide.

The copolyamide described above constitutes the matrix of the composition according to the invention.

### The Thermally Conductive Filler

The composition according to the invention comprises from 3% to 35% by weight, with respect to the total weight of the composition, of at least one thermally conductive filler, the content of carbon atoms of which is of between 80% and 100%, with respect to the number of atoms constituting the filler. Preferably, the filler comprises from 94% to 99.99% of carbon atoms.

The carbon-based filler can be chosen from natural graphites, synthetic graphites, expanded graphites, graphenes, carbon blacks and carbon fibers. Preferably, the filler is chosen from natural graphites, synthetic graphites and expanded graphites.

The graphite used in the composition according to the invention can be produced synthetically or naturally. There exist three types of naturally produced graphite which are available commercially. These are flake graphite, amorphous graphite and crystalline graphite.

Flake graphite, as its name suggests, exhibits a flake morphology. Amorphous graphite is not really amorphous, as its name suggests, but is in fact crystalline. Amorphous graphite is available in mean sizes from approximately 5 micrometers to approximately 10 centimeters. Crystalline graphite generally exhibits a vein appearance on its external surface, hence its name. Crystalline graphite is commercially available in the form of flakes from Asbury Graphite and Carbon Inc Carbons.

Synthetic graphite can be produced from coke and/or pitch which are derived from petroleum or coal. Synthetic graphite is of greater purity than natural graphite but is not as crystalline. One type of synthetic graphite is electrographite, which is produced from calcined petroleum coke and from coal tar pitch in an electric furnace. Another type of synthetic graphite is produced by heating calcined petroleum pitch at 2800° C. Synthetic graphite tends to have a lower density, a higher porosity and a higher electrical resistance than natural graphite.

Preferably, the thermally conductive filler exhibits a median mean particle size D50 ranging from 0.5 to 500 micrometers. In this range, the filler particles having D50 sizes of from 1 to 200 μm, preferably from 20 to 150 μm, can advantageously be used.

Preferably, the thermally conductive filler exhibits a median mean particle size D90 ranging from 1 to 400 micrometers, advantageously from 2 to 200 μm, very advantageously from 5 to 150 μm.

The D50 and D90 values can be estimated according to the standard ISO 13320-1:1999.

In one embodiment, the thermally conductive filler, and consequently the composition, does not comprise particles with a diameter of greater than 500 μm, advantageously does not comprise particles with a diameter of greater than 400 μm.

When the carbon-based filler is not 100% composed of carbon, the impurities are preferably chosen from the following chemical entities: SiO₂, Fe₂O₃, Al₂O₃, CaO, MgO, K₂O, Na₂O, TiO₂, MnO or P₂O₅.

According to one embodiment, the BET specific surface, measured according to ISO 9277:2010, is of between 1 and 300 m²/g, very advantageously between 1.5 and 200 m²/g.

Preferably, these fillers exhibit a mean form factor of greater than 3, advantageously of greater than 7, very advantageously of greater than 15.

Scanning electron microscopy makes possible observation and visual assessment of the morphology of the compounds. Morphometry, based on video acquisition and on image analysis, makes it possible to access quantifiable parameters characteristic of the morphology of the particles. Various commercial devices exist: mention may be made, by way of example, of the Morphologi G2 appliance from Malvern, the Camsizer appliance from Retsch and the Alpaga 500 Nano appliance from Occhio, described on the Internet pages www.malvern.com, www.retsch-technology.com or also www.occhio.be.

By means of the Alpaga 500 Nano apparatus, for each sample tested, acquisitions are carried out on 10 000 particles and the elongation and bluntness parameters are calculated for each particle.

The mathematical tools used for their calculation are developed in the doctoral thesis of E. Pirard (1993, University of Liège, 253 pages) entitled “Morphométrie euclidienne des figures planes. Applications à l'analyse des matériaux granulaires” [Euclidean morphometry of flat figures. Applications in the analysis of granular materials]. The document entitled “The descriptive and quantitative representation of particle shape and morphology” is available under the reference ISO/DIS 9276-6.

Preferably, the thermally conductive filler exhibits a density of less than 3 kg/l, advantageously of less than 2.5 kg/l, very advantageously of less than 2.3 kg/l. The density is measured by following the standard ISO 787-10:1993.

Preferably, when the thermally conductive filler is expanded graphite, then it is present in the composition according to the invention in a content of between 5% and 17% by weight, with respect to the total weight of the composition. Preferably, the expanded graphite is the sole thermally conductive filler of the composition.

When the thermally conductive filler is not expanded graphite, then it is present in the composition according to the invention in a content of between 5% and 35% by weight, with respect to the total weight of the composition. Preferably, when the thermally conductive filler is not expanded graphite, then it is present in the composition in a content of between 10% and 29.90%, preferentially between 15% and 25%.

### The Additives

The composition according to the invention can comprise at least one additive.

The additive can be chosen from a catalyst, an antioxidant, a heat stabilizer, a UV stabilizer, a light stabilizer, a lubricant, a flame retardant, a nucleating agent, a chain extender and a dye.

Advantageously, the composition defined above furthermore comprises additives chosen from antioxidants, UV stabilizers, heat stabilizers, plasticizers, nucleating agents, tackifiers, impact modifiers, flame retardants, antistatic agents, reinforcing agents, lubricants, organic and inorganic fillers, optical brighteners, mold-release agents, pigments, dyes, catalysts and their mixtures.

The composition can comprise between 0% and 10% by weight of additives, with respect to the total weight of the composition, preferably between 0.1% and 5% of additive.

The composition comprises less than 20%, very advantageously less than 10%, preferably less than 5%, of components having a density of greater than 3.

Within the meaning of the present invention, the term “component” is understood to mean any product present in the composition according to the invention, whatever its chemical nature. In other words, less than 20% of the fillers and additives possibly present in the composition have to exhibit a density of greater than 3.

According to a particular embodiment of the invention, the composition consists of the copolyamide as defined above as matrix, of from 3% to 35% by weight, with respect to the total weight of the composition, of at least one thermally conductive filler, the content of carbon atoms of which is of between 80% and 100%, and from 0% to 10% by weight of additives, with respect to the total weight of the composition, the composition comprising less than 20% of components having a density of greater than 3 (measured according to ISO 787-10:1993).

The melt viscosity of the composition is preferably of between 0.5 and 400 Pa·s, advantageously between 2 and 200 Pa·s, very advantageously between 3 and 100 Pa·s. The melt viscosity is measured with the help of a Brookfield rheometer using the SC 4-27 module according to the standard ASTM D3236-88 (2009) at 210° C.

Preferably, the composition according to the invention thus exhibits a surface resistivity of greater than 1010 Ω·m, preferably of greater than 1011 Ω·m, measured according to the standard IEC 62631-3-2 (2015). In other words, the composition is electrically insulating.

The composition according to the invention preferably exhibits an elongation at break (during ISO 527 tensile tests at 23° C.) of greater than 10%, advantageously of greater than 30%.

The tensile modulus at 23° C. of the composition, measured on a 1A test specimen (ISO 527), is preferably of between 100 and 5000 MPa, advantageously between 200 and 4000 MPa, very advantageously between 200 and 800 MPa.

The composition preferably exhibits a dielectric constant (Dk), measured at 1 GHz, of preferably between 2 and 6, advantageously from 2.5 to 4, and a dissipation factor (tan δ) of between 0.001 and 0.1, advantageously between 0.005 and 0.05.

The dielectric constant and the dissipation factor are measured according to the standard ASTM D150 on a 100*100*2 mm sheet at a frequency of 1 GHz.

The composition according to the invention exhibits a thermal conductivity of between 0.9 W/m·K and 4 W/m·K, advantageously from 1 W/m·K to 3 W/m·K, measured according to the standard ASTM D5930-17.

The invention also relates to the encapsulation process using the composition according to the invention.

The composition according to the invention is used to manufacture molded parts by low-pressure injection molding. This injection-molding cycle can comprise the various following stages:
a) the mold is closed after the parts to be adhesively bonded have been inserted,
(b) the molten composition according to the invention is injected into the mold up to a pressure of between 0.5 and 50 bar and optionally subjected to a holding pressure,
(c) the molding composition is left to solidify by cooling,
d) the mold is opened,
e) the injection-molded parts are withdrawn from the mold.

The low-pressure injection molding process generally operates in the range from 2 to 40 bar, the temperature being of between 16° and 250° C.

Thus, the composition according to the invention is capable of being injected at low pressure, that is to say at a pressure of less than 100 bar, preferably of less than 50 bar.

### Use

According to yet another aspect, the present invention relates to the use of the composition according to the invention as defined above for the encapsulation of electronic devices, also called overmolding or molding, which are preferably located under the engine hood of a vehicle or in medical appliances.

The present invention also relates to the use of the composition according to the invention as defined above for the manufacture of a hot-melt adhesive in the form of a web, a film, granules, a filament, a grid or a powder.

The melt viscosity of the composition is of between 0.5 and 400 Pa·s, advantageously between 2 and 200 Pa·s, very advantageously between 3 and 100 Pa·s. The melt viscosity is measured with the help of a Brookfield rheometer using the SC 4-27 module according to the standard ASTM D3236-88 (2009) at 210° C. a powder.

The invention is illustrated by the following figure and examples which are in no way limiting.

### Examples

### 1. Preparation of Compositions and Measurements

The compositions were obtained by melt mixing of the components described in tables 1 and 2 below.

All the above compositions were manufactured using a 18 mm ZSK twin-screw extruder (Coperion). The temperature of the barrels was set at 210° C. and the speed of the screws was 280 rpm with a flow rate of 8 kg/h. The compositions were subsequently dried under reduced pressure at 80° C. in order to achieve a moisture content of less than 0.04%.

1A test specimens (according to the standard ISO 527) and 5 mm plaques were manufactured by injection molding with the help of a Battenfeld® BA800 CDC press using unpolished molds. The following parameters were applied during the injection:
Temperature of the barrel: 120° C.
Temperature of the nozzle: 150° C.
Temperature of the mold: 15° C.
Cycle time: 60 seconds.

TABLE 1

| | 1 | 2 | 3 | 4 |
|---|---|---|---|---|
| | Inv | Inv | Inv | Inv |
| | % by | % by | % by | % by |
| | weight | weight | weight | weight |
| Polyamide¹ | 92 | 90 | 85 | 85 |
| Expanded | 8 | 10 | 15 | — |
| graphite² | | | | |
| Graphite³ | — | — | — | 15 |
| Resistivity | >10¹¹ | >10¹¹ | >10¹¹ | >10¹¹ |
| (Ω · m) | | | | |
| Conductivity λ | 0.542 | 0.609 | 0.929 | 0.626 |
| (W/m · K) | | | | |
| Sedimentation | no | no | no | no |

In table 1 above:
¹Polyamide denotes a hot-melt adhesive polyamide composed of 31 mol % of C₁₀ diacid, 19 mol % of Pripol ® 1013, 25 mol % of piperazine, 6.6 mol % of Jeffamine ® D-2000 and 18.4 mol % of ethylenediamine.
The Tg of the polyamide is −22° C., measured in DSC, and a viscosity of 9 Pa · s at 200° C., measured according to the standard ASTM D3236-88 (2009).
The formula of polyamide A is 210/pip10/pip36/POP36, pip being piperazine and POP being Jeffamine ® D-2000. The nomenclature used to define polyamides is described in the standard ISO 1874-1: 1992, “Plastics - Polyamide (PA) moulding and extrusion materials - Part 1: Designation”, in particular on page 3 (tables 1 and 2).
²Expanded graphite denotes graphite having the brand name Timrex ® C Therm HD max with a density of less than 2.5 sold by Imerys.
³Graphite denotes graphite having the brand name Timrex ® M100 with a density of less than 2.5 sold by Imerys.

TABLE 2

| | 5 Inv | 6 Inv | 7 Comp | 8 Comp | 9 comp | 10 comp |
|---|---|---|---|---|---|---|
| | % by | % by | % by | % by | % by | % by |
| | weight | weight | weight | weight | weight | weight |
| Polyamide A¹ | 75 | 65 | 60 | 59.5 | | |
| Polyamide B⁶ | | | | | 75 | 92 |
| Graphite³ | 25 | 35 | 40 | — | 25 | 8 |
| Expanded | — | — | — | 1 | | |
| graphite² | | | | | | |
| Aluminum oxide⁴ | — | — | — | 32 | | |
| Boron nitride⁵ | — | — | — | 7.5 | | |
| Resistivity (Ω · m) | >10¹¹ | 2.1012 | 4.106 | ND | >10¹¹ | >10¹¹ |
| Conductivity λ | 0.857 | 1.250 | ND | ND | ND | ND |
| (W/m · K) | | | | | | |
| Sedimentation | no | no | no | yes | no | no |
| Processability | OK | OK | OK | OK | No: too | No: too |
| for the | | | | | viscous | viscous |
| encapsulation | | | | | | |

In table 2 above:
¹Polyamide A denotes a hot-melt adhesive polyamide composed of 31 mol % of C₁₀ diacid, 19 mol % of Pripol ® 1013, 25 mol % of piperazine, 6.6 mol % of Jeffamine ® D-2000 and 18.4 mol % of ethylenediamine.
⁶Polyamide B denotes a PA 6 having a melting point of 220° C. and a melt viscosity, measured according to the standard ASTM D3236-88 (2009), of 325 Pa · s at 280° C.
³Graphite denotes graphite having the brand name Timrex ® M100 with a density of less than 2.5 sold by Imerys.
²Expanded graphite is sold under the name C Therm ® HD max with a density of less than 2.5 by Imerys.
⁴Aluminum oxide is sold under the name Martoxid ® TM 4250 with a density of greater than 3 by Martinswerk.
⁵Boron nitride is sold under the name 19-E-01-HF-02 by Henze with a density of 2.3.

In these examples, the thermal and electrical properties of these compositions were measured according to the following methods. The homogeneity of these melt compositions was also evaluated.

### Thermal Conductivity

The thermal conductivity was measured at 23° C. on 100*100*5 mm plaques using the Neotim® FP2C machine equipped with a hot wire by following the standard ASTM D5930-17.

### Resistivity

Measurements according to the standard IEC 62631-3-2 (2015) were carried out on the Sefelec® M1500P equipped with the 8009 cell, with the following conditions:
Potential difference: 40V
Charging time before reading: 60 sec
Thickness of the plaques: 100*100*5 mm

### Homoaeneity and Sedimentation

Granules of the compositions are placed in a test tube immersed in a silicone oil bath at 15° C. above the Tm of the copolyamide for 30 minutes. On conclusion of the 30 minutes, the tube is placed in ambient air until the composition has solidified. The tube is subsequently broken in order to recover the composition.

If sedimentation is significant, an accumulation of fillers is observable in the bottom of the tube.

If this is not the case, the sample is cut in two (top part separated from the bottom part of the tube) in order to estimate the densities at 23° C. according to ISO 1182-1 of the top and bottom parts of the sample. If the difference in density is greater than 0.3, sedimentation is considered to be too great.

### 2. Conclusions

The results show that the composition according to the invention makes it possible to encapsulate parts at low pressure using a melter. The composition according to the invention exhibits a good thermal conductivity making it possible to avoid overheating of the items of electronic equipment while being electrically insulating, which makes it possible to avoid short circuits.

Compositions 9 and 10 cannot be used in an overmolding process due to their excessively high viscosities and melting points.

1-17. (canceled)

18. A hot-melt adhesive composition comprising:
(i) at least one semicrystalline aliphatic copolyamide comprising at least two units corresponding to the following formula (1):
X/Y (1)
in which:
the unit X is a semicrystalline unit obtained by the polycondensation of a unit chosen from a C₆ to C₁₈ α,ω-aminocarboxylic acid, a C₆ to C₁₈ lactam, and a (Ca diamine)·(Cb diacid) unit, with a representing the number of carbon atoms of the diamine and b representing the carbon number of the diacid, a being between 2 and 18 and b being between 4 and 18, the Ca diamine and the Cb diacid being saturated or unsaturated, linear or branched aliphatic or cycloaliphatic,
the unit Y is a unit obtained by the polycondensation of a (Cd diamine)·(Ce diacid) unit, with d representing the number of carbon atoms of the diamine and e representing the carbon number of the diacid, d, and e being between 2 and 48, the Cd diamine and the Ce diacid being saturated or unsaturated, linear or branched aliphatic or cycloaliphatic, it being possible for the Cd diamine to be a polyetheramine,
the unit Y exhibiting a Tg of less than 30° C.,
the copolyamide exhibiting a melt viscosity, measured according to the standard ASTM D3236-88 (2009), of between 0.5 and 300 Pa·s at 200° C.,
the copolyamide constituting the matrix of the composition,
(ii) from 3% to 35% by weight, with respect to the total weight of the composition, of at least one thermally conductive filler, the content of carbon atoms of which is between 80% and 100%, with respect to the number of atoms constituting the filler,
the composition comprising less than 20% of its components having a density of greater than 3.

19. The composition as claimed in claim 18, characterized in that the thermally conductive filler is selected from the group consisting of natural graphites, synthetic graphites, expanded graphites, graphenes, carbon blacks, and carbon fibers.

20. The composition as claimed in claim 18, characterized in that the thermally conductive filler exhibits a median mean particle size D50 ranging from 0.5 to 500 micrometers.

21. The composition as claimed in claim 18, characterized in that the thermally conductive filler exhibits a median mean particle size D90 ranging from 1 to 400 micrometers.

22. The composition as claimed in claim 18, characterized in that the thermally conductive filler exhibits a mean form factor of greater than 3.

23. The composition as claimed in claim 18, characterized in that composition comprises less than 10%, of its components having a density of greater than 3.

24. The composition as claimed in claim 18, characterized in that the copolyamide comprises a crystalline unit X chosen from caprolactam, enantholactam and lauryllactam, 7-aminoheptanoic acid, 11-aminoundecanoic acid and 12-aminododecanoic acid, PA 26, PA 29, PA 210, PA 212, PA 214, PA 218, PA 56, PA 59, PA 510, PA 66, PA 69, PA 610, PA 512, PA 612, PA 514, PA 614, PA 618, PA pip10, PA pip12, PA 1010, PA 1012, PA 1014, PA 1018, PA 1210, PA 1212, PA 1214 and PA 1218.

25. The composition as claimed in claim 18, characterized in that the copolyamide comprises a unit Y chosen from PA 236, PA 536, PA 636, PA 1036, PA pip36, PA pip44, PA 244, PA 544, PA 644, PA 1044, PA POP36, PA POP44, PA POP6, PA POP9, PA POP10, PA POP12 or PA POP14, POP being a polyetheramine with a molar mass of between 60 and 2000 g/mol.

26. The composition as claimed in claim 18, characterized in that the copolyamide comprises at least one of the units chosen from PA 26, PA 29, PA 210, PA 212, PA 214, PA 218, PA 56, PA 59, PA 510, PA 512, PA 66, PA 69, PA 610, PA 612, PA 6, PA 11, PA 12, PA 1010, PA 1012, PA 1212, PA pip10, PA pip36, PA pip44, PA POP40036, PA POP40044, PA POP40010, PA POP4006, PA POP200036, PA POP200044, PA POP200010, PA POP20006, PA3636, PA3644, PA 4436, PA 4444 and their mixture.

27. The composition as claimed in claim 18, characterized in that the copolyamide is chosen from PA 6/3636, PA 11/3636, PA 12/3636 and PA 11/3636/pip36.

28. The composition as claimed in claim 18, characterized in that the composition exhibits a melt viscosity ranging from 0.5 to 400 Pa·s at 210° C.

29. The composition as claimed in claim 18, characterized in that the composition comprises expanded graphite in a content between 5% and 17% by weight, with respect to the total weight of the composition, as sole thermally conductive filler of the composition.

30. The composition as claimed in claim 18, characterized in that the composition exhibits a surface resistivity of greater than 10¹⁰ Ω·m, measured according to the standard IEC 62631-3-2 (2015).

31. The composition as claimed in claim 18, characterized in that the composition exhibits a thermal conductivity of between 0.9 W/m·K and 4 W/m·K, measured according to the standard ASTM D5930-17.

32. The composition as claimed in claim 18, characterized in that the composition comprises additives chosen from antioxidants, UV stabilizers, heat stabilizers, plasticizers, nucleating agents, tackifiers, impact modifiers, flame retardants, antistatic agents, reinforcing agents, lubricants, organic and inorganic fillers, optical brighteners, mold-release agents, pigments, dyes, catalysts and their mixtures.

33. The composition as claimed in claim 18, characterized in that the composition is capable of being injected at a pressure of less than 100 bar.

34. An electronic device assembly comprising an electronic device and the composition as defined in claim 18, wherein the electronic device is encapsulated in the composition.
